(19) United States
(12) Patent Application Publication
(10) Pub. No.: US 2023/0051377 A1
(43) Pub. Date: Feb. 16, 2023

(54) MOBILITY MOVEMENNT INFORMATION ACQUIRING METHOD AND MOBILITY MOVEMENT INFORMATION ACQUIRING APPARATUS

(71) Applicant: SmartDrive Inc., Tokyo (JP)

(72) Inventors: Hiroki MOTOGAITO, Tokyo (JP); Taiki KANDA, Tokyo (JP); Yoshiki OBATA, Tokyo (JP); Ryo ONO, Tokyo (JP)

(73) Assignee: SmartDrive Inc., Tokyo (JP)

(21) Appl. No.: 17/793,919

(22) PCT Filed: Sep. 22, 2021
(86) PCT No.: PCT/JP2021/034796

§ 371 Date: Jul. 19, 2022

(30) Foreign Application Priority Data
Oct. 30, 2020 (JP) 2020-183038
Sep. 1, 2021 (JP) 2021-142298

(51) Int. Cl. G01P 15/16; G01P 15/18

(52) U.S. Cl. CPC G01P 15/16; G01P 15/18

(57) ABSTRACT

A mobility movement information acquiring method has: acquiring an observed velocity value of a mobility according to a first interval; storing the observed velocity value and corresponding time information so as to relate each other; and acquiring an acceleration value in a travelling direction by inputting the observed velocity value into a state-space model in which: displacement per unit time of a state velocity value is the acceleration value in the travelling direction, the observed velocity value is a sum of the state velocity value and a value following a first distribution, and displacement per the unit time of the acceleration value in the travelling direction follows a second distribution.

### TECHNICAL FIELD

The present disclosure relates to information processing technologies of acquiring information pertaining to mobility movement.

### BACKGROUND ART

There is a need to acquire information about a mobility (for example, mobilities such as automobile, bicycle, ship, etc., also including walking as its concept) used by a user, for example, acceleration, velocity, angular velocity, etc., and a demand to use it for analysis of some kinds. For example, there is a social demand for conducting driving evaluation based on these information, and Patent Document 1 discloses a driving diagnosis system that generates statistical information based on time-series information regarding acceleration where acceleration is collected as vehicle movement data from various sensors installed in the vehicle via a car navigation device. is disclosed.

### CITATION LIST

### Patent Document

Patent Document 1: JP 2006-243856A

### SUMMARY

### Problems to be Solved

There are some problems when acquiring data regarding the movement of a mobility from an accelerometer installed on the mobility is intended. One is that it is difficult to correctly recognize the traveling direction of the mobility consistently. As a method for recognizing the travelling direction thereof, a direction in which the acceleration is generated is detected when the transition from the stationary state where the acceleration value is substantially 0 is changed to the operating state where the acceleration value becomes a certain value or more is detected as the traveling direction. In this method, however, there may be a case where the vehicle is started in the back direction or the vehicle is started while the steering wheel is not at the center position, and therefore there is a problem that the traveling direction cannot always be correctly recognized.

Another issue is that with a mobility such as a motorcycle, the driver needs to put one foot on the ground when stopping, for example, at a traffic light, which naturally causes the vehicle body to tilt. Therefore, the vertical direction of the sensor (acceleration sensor, etc.) installed on the mobility does not correspond to the vertical direction during operation, making it difficult to accurately determine the vertical direction and correspondingly difficult to measure acceleration, etc. in the horizontal direction.

Yet another issue is that it is difficult to acquire accurate values when acquiring information about a mobility due to the effects of noise and other factors. Therefore, if the acquired values were used for analysis as they were, there was a risk that the analysis results could not be acquired properly.

### Means to Solve Problems

In accordance with one aspect of the invention, a mobility movement information acquiring method comprises: acquiring an observed velocity value of a mobility according to a first interval; storing the observed velocity value and corresponding time information so as to relate each other; and acquiring an acceleration value in a travelling direction by inputting the observed velocity value into a state-space model in which: displacement per unit time of a state velocity value is the acceleration value in the travelling direction, the observed velocity value is a sum of the state velocity value and a value following a first distribution, and displacement per the unit time of the acceleration value in the travelling direction follows a second distribution.

### Effect of the Invention

According to the method of the present invention, the effect is that information on the movement of a mobility can be acquired appropriately.

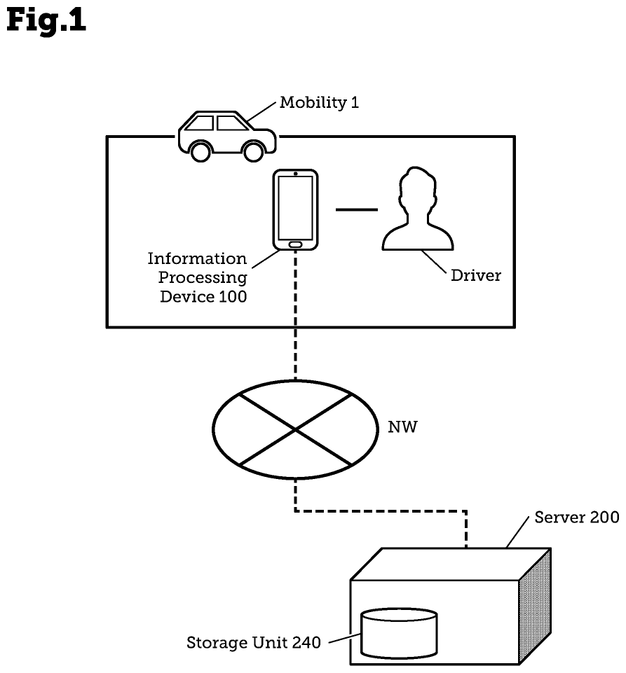

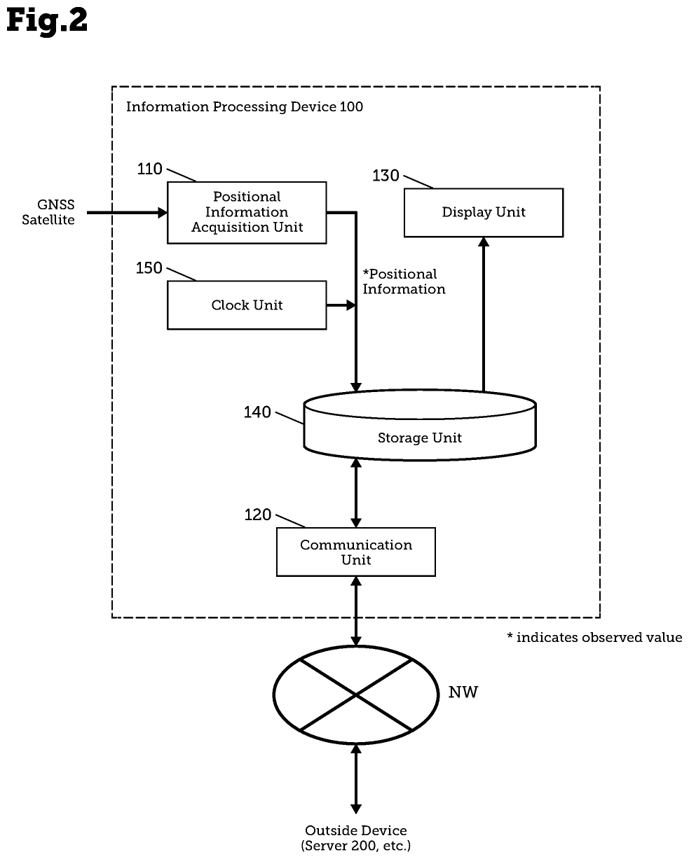

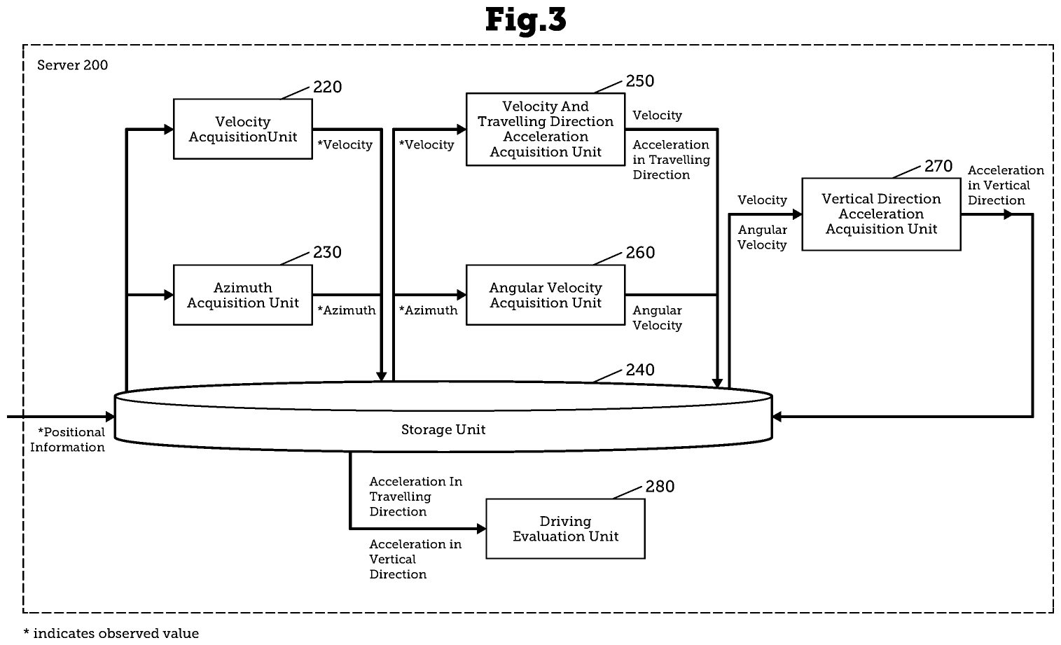

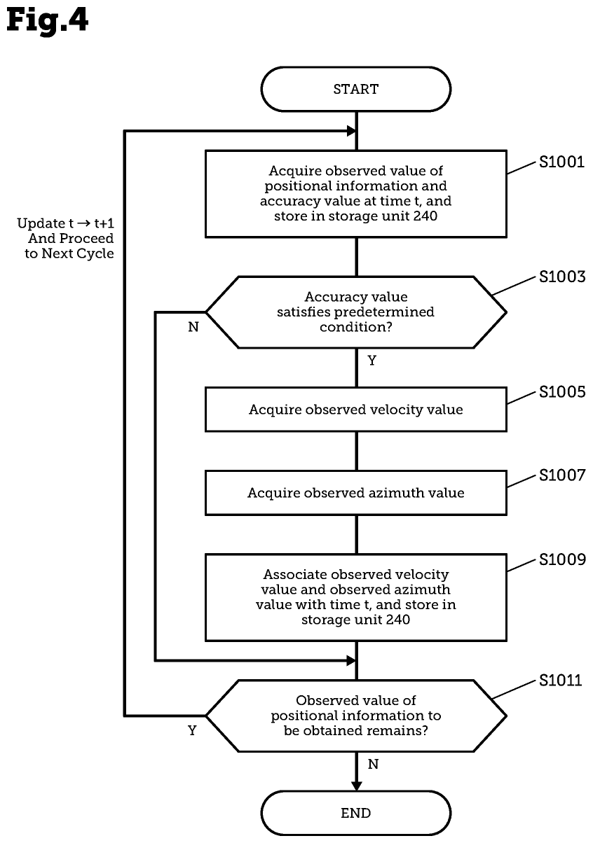

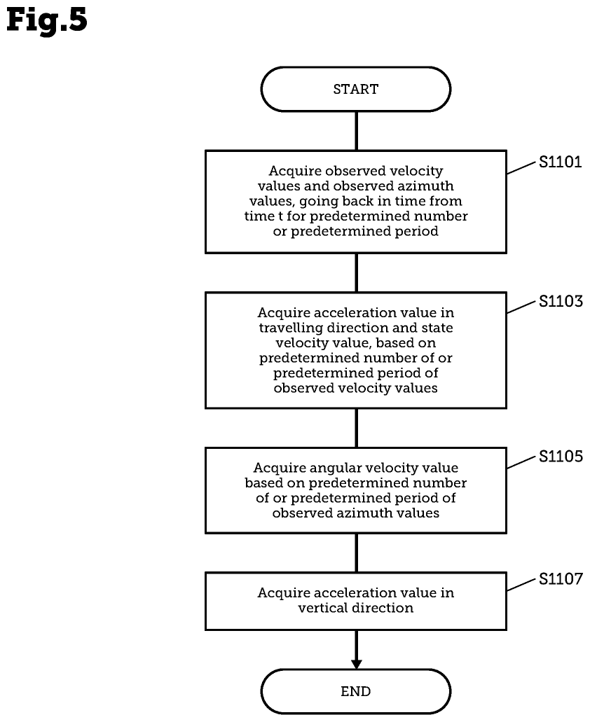

### BRIEF DESCRIPTION OF DRAWINGS

[FIG. 1] A system configuration diagram of a mobility movement information acquisition system in the first embodiment.

[FIG. 2] A block diagram illustrating the schematic configuration of an information processing device 100 in the first embodiment.

[FIG. 3] A block diagram explaining the schematic configuration of a server 200 in the first embodiment.

[FIG. 4] A flowchart showing an example of the procedure for acquiring an observed velocity value and an observed azimuth value, and storing those observed values in the first embodiment.

[FIG. 5] A flowchart showing an example of the procedure for acquiring an acceleration value in a travelling direction, an angular velocity value, and an acceleration value in the vertical direction of the mobility 1 at time t in the first embodiment.

### DESCRIPTION OF EMBODIMENTS

An example of an embodiment of the present invention will be described below with reference to the drawings.

In the description of the drawings, identical elements are marked with the same symbol and duplicate explanations may be omitted.

The components described in these embodiments are only examples, and are not intended to limit the scope of the invention to them.

In the following description of the present invention, the terms “state value” and “observed value” are used to have the meanings as the following.

“state value”: A true value that corresponds to a certain state of each piece of information (e.g., velocity) related to the movement of a mobility. Normally, it is difficult to correctly acquire it from the outside due to noise or other influences.

“observed value”: A value acquired by attempting to acquire the aforementioned state value from the outside. Furthermore, it is a value calculated based on these observed values without considering the influence of noise, etc. (e.g., a velocity value calculated based on the observed values of positional information without considering noise, etc.).

### First Embodiment

The following is a description of the first embodiment for realizing the information processing technology of the present invention.

The contents described in the first embodiment are applicable to each of the other embodiments, each of the examples, and each of the other variations.

FIG. 1 is a system configuration diagram of a mobility movement information acquisition system in accordance with the first embodiment. In this system, a positional information acquiring unit 110 provided in an information processing device 100 carried by a passenger of the mobility 1, acquires observed positional information of the mobility 1 and transmits it to a server 200. At the server 200, based on the transmitted observed value of positional information, information about the movement of the mobility 1, such as a state value of the velocity (state velocity value), an acceleration value in the travelling direction, an angular velocity value, and an acceleration value in the vertical direction, is acquired.

FIG. 2 is a block diagram showing the functional structure of the information processing device 100 of FIG. 1. Description hereinafter is made under the assumption that the information processing device 100 is a portable terminal such as a smartphone or tablet as an example, but it is not limited to these portable devices. For example, the information processing device 100 may not be the one carried by a driver or non-driver boarding in the mobility 1, but may be a device installed in the mobility 1, such as a car navigation device or a drive recorder device. As shown in FIG. 2, the information processing device 100 includes, for example, a positional information acquisition unit 110, a communication unit 120, a display unit 130, and a storage unit 140, and these are, for example, functional parts (functional blocks) realized by an unshown processing part (processing unit) or control part (control unit) of the information processing device 100, being composed of a processor such as a CPU and integrated circuits such as an ASIC.

The positional information acquisition unit 110, for example, can be used to chronologically acquire observed values of positional information (e.g., latitude and longitude information) based on radio waves arriving from GNSS satellites (e.g. GPS satellites). The following is a preferable example of a case in which this acquisition of observed values of positional information be performed at predetermined time intervals (e.g., every second). In other words, it is possible to acquire an observed value of positional information of the information processing device 100 carried by a person. In turn, when the person carrying the information processing device 100 uses the mobility 1, an observed value of the positional information of the mobility 1 can be substantially acquired. The acquired observed value of positional information is associated with the time at which said positional information is acquired (current time) and stored in the storage unit 140.

Here, the positional information acquisition unit 110 acquires an observed value of the positional information by GPS and also acquires an accuracy value indicating the accuracy of the positional information (e.g. positional accuracy, such as 5 m, 10 m, 100 m, a DOP value, etc.) may also be acquired. In this case, the acquired observed positional information value and accuracy value are associated with the acquired time and stored in the storage unit 140.

The method of acquiring observed values of positional information by the positional information acquisition unit 110 is not limited to those described above, and any positional information acquisition method may be applied. For example, the positional information acquisition unit 110 may acquire observed values of positional information when the mobility 1 equipped with the information processing device 100 approaches a roadside unit installed on the side of a road, emitting a radio wave that contains positional information specific to the roadside unit, and the positional information acquisition unit 110 may receive the emitted radio wave as positional information.

The communication unit 120 is configured to communicate with a network NW such as Internet. For its communication, several communication methods, for example, a wired connection via a cable compliant with a specified communication standard, such as Ethernet or USB (Universal Serial Bus), or a wireless connection compliant with specified communication standards such as Wi-Fi (registered trademark), 5G (5th generation mobile communication system). technology, short-range wireless various methods such as Bluetooth (registered trademark) and any other connection using telecommunications can be applied.

Communication by the communication unit 120 is not limited to the above. For example, the communication unit 120 can transmit and receive information to a roadside unit installed on the side of the road, and the roadside unit can transmit and receive information to the outside such as the server 200, etc., through the network NW, thereby it may communicate indirectly with the server 200, etc.

The communication unit 120 transmits the received data from the outside to the storage unit 140 to store it, and transmits data such as an observed value of positional information stored in the storage unit 140 to the outside (e.g., server 200) via the network NW.

The display unit 130 is a display device that includes a liquid crystal display (LCD), OELD (Organic Electro-Luminescence Display), etc., and displays various information according to information stored in the storage unit 140, based on display signals output from an unshown control unit.

The display unit 130 may have an unshown touch panel integrally configured therewith, so that the touch panel functions as an input interface between the user and the information processing device 100.

The storage unit 140 can be, for example, a hard disk drive (HDD), an SSD (Solid State Drive), an EEPROM (Electrically Erasable Programmable Read-Only Memory), a ROM (Read-Only Memory), a RAM (Random Access Memory), or the like. In addition to storing various data, control programs, etc. to be processed by information processing device 100, storage unit 140 stores and accumulates observed values of the positional information acquired by the positional information acquisition unit 110, and the time information acquired by the clock unit 150, and stores and accumulates information output by other functional parts. The storage unit 140 is not limited to those built into the information processing device 100. The storage unit 140 can be an external storage device connected by a digital input/output port such as USB (Universal Serial Bus).

The clock unit 150 is a built-in clock of the information processing device 100, and output time information acquired based on, for example, a clock using a crystal oscillator (timekeeping information). The clock unit 150 may acquires time information in accordance with the NITZ (Network Identity and Time Zone) standard or the like, via the communication unit 120 and the network NW.

The server 200 performs various processes based on observed values of positional information transmitted from the information processing device 100, and the like. For example, the server 200 performs the following processes: one for acquiring observed velocity values based on the observed values of positional information, one for acquiring observed azimuth values based on the observed values of positional information, one for acquiring acceleration values in the travelling direction based on the observed velocity values, one for acquiring state velocity values from the observed velocity values, one for acquiring angular velocity values based on the observed azimuth values, one for acquiring acceleration values in the vertical direction from the state velocity values and the angular velocity values, and so on. Details of these processes are described below.

FIG. 3 is a block diagram showing the functional structure of the server 200. The server 200 is configured, for example, as a single server or as a distributed server consisting of separate servers for each function. The server 200 can also be configured as a distributed virtual server created in a cloud environment, called a cloud server.

The server 200, as shown in FIG. 3, has, for example, a velocity acquisition unit 220, an azimuth acquisition unit 230, a storage unit 240, a velocity and travelling direction acceleration acquisition unit 250, an angular velocity acquisition unit 260, a vertical direction acceleration acquisition unit 270, a driving evaluation unit 280, and so on. These are, for example, functional parts (functional blocks) possessed by an unshown processing part (processing unit) or control part (control unit) provided in the server 200, being composed of a processor such as a CPU and integrated circuits such as an ASIC.

The velocity acquisition unit 220 acquires an observed velocity value by acquiring observed values of two positional information composed of one that is acquired at a certain time (for ease of description, time t) and another that is acquired before the time t with respect to a predetermined cycle (hereinafter, “acceleration information acquisition cycle”. For ease of description, time that is one acceleration information acquisition cycle after time t is time t+1, and subsequently, t+2, t+3, . . . ), and calculates the observed velocity value at time t based on the observed values of the two positional information. The acquired observed velocity value is associated to time t and stored in storage unit 240.

The “velocity” in the present embodiment is the magnitude of the velocity in the travelling direction of the mobility 1, and the vertical direction of the velocity does not need to be considered in the present embodiment. Therefore, information regarding velocity may not be retained as two-dimensional information. The magnitude and direction of the velocity can be comprehended along with the azimuth information, which is described below.

Here, when an observed velocity value of the mobility 1 is to be acquired, the information processing device 100 may perform the corresponding process, not the server 200. In this case, the observed velocity value acquired at the information processing device 100 is transmitted to the server 200, and stored in storage unit 240 so as to associate with the time information.

The azimuth acquisition unit 230 is, similar to the process by the velocity acquisition unit 220, acquires an observed azimuth value by acquiring observed values of two positional information composed of one that is acquired at time t and another that is acquired before the time t with respect to a predetermined cycle, and calculates an observed azimuth value at time t based on an angle constructed by the observed values of the two positional information. The azimuth value here means, for example, the size of the horizontal angle measured in the clockwise direction with respect to true north. Of course, the definition of azimuth angle is not limited to this, and may be based on any direction (e.g., true south) or the size of the horizontal angle measured in the counterclockwise direction. The observed azimuth value is associated to time t and stored in storage unit 240.

The storage unit 240 is, for example, a hard disk drive (HDD), an SSD (Solid State Drive), and an EEPROM (Electrically Erasable Programmable Read-Only Memory), a ROM (Read-Only Memory), a RAM (Random Access Memory), or the like. In addition to storing various data, control programs, etc. to be processed by server 200, storage unit 240 stores and accumulates an observed velocity value at time t acquired by the velocity acquisition unit 220 and an observed azimuth value at time t acquired by the azimuth acquisition unit 230, and information output by other function units. The storage unit 240 can be an external storage device connected by a digital input/output port such as USB (Universal Serial Bus).

The velocity and travelling direction acceleration acquisition unit 250 acquires an acceleration value in the travelling direction and a state velocity value of the mobility 1, based on the observed velocity values at each time output and accumulated by the velocity acquisition unit 220, and stores the acceleration value in the travelling direction and the state velocity value in the storage unit 240, so as to associate to the time information. The details of the process for acquiring an acceleration value in the travelling direction and a state velocity value are described below.

The angular velocity acquisition unit 260 acquires, similar to the process by the velocity and travelling direction acceleration acquisition unit 250, an angular velocity value of the mobility 1 based on the observed azimuth values at each time output and accumulated by the azimuth acquisition unit 230, and stores the angular velocity value in the storage unit 240 so as to associate to the time information. Details of this process by the angular velocity acquisition unit 260 are described below.

The vertical direction acceleration acquisition unit 270 acquires an acceleration value in the vertical direction based on a state velocity value acquired by the velocity and travelling direction acceleration acquisition unit 250, and an angular velocity value acquired by the angular velocity acquisition unit 260, and stores the acceleration value in the vertical direction in the storage unit 240 so as to associate to the time information. Details of this process by the vertical direction acceleration acquisition unit 270 are described below.

The driving evaluation unit 280 evaluates the driving of the mobility 1 based on information about the movement of the mobility 1, such as the acceleration value in the traveling direction, the acceleration value in the vertical direction, etc. Specifically, for example, in regard to the acceleration information acquired at each of predetermined time unit is used for determining whether a scalar value thereof exceeds a predetermined threshold value, whether they exceed a predetermined threshold value at consecutive predetermined number of times, or whether there are times more than predetermined number of times in which the scalar value exceeds a predetermined threshold value within a predetermined time period. The system determines whether the driving was safe or unsafe and outputs the result thereof, or converts the result of being safe or unsafe into a score and outputs the score. In this case, the magnitude of the threshold value may be varied according to the direction of the acceleration vector (forward/backward or left/right). For example, the threshold value for the forward direction may be set lower or higher than the threshold value for the backward direction, the threshold value for the left/right direction (sudden steering) may be set lower or higher than the threshold value for the forward/backward direction (sudden acceleration or sudden braking), or they may be the same.

### [Information Processing Procedures]

FIG. 4 is a flowchart showing an example of the procedure for acquiring an observed velocity value and an observed azimuth value, and storing these values in the first embodiment.

Performing the processes in the flowchart in FIG. 4 is realized, for example, by the processing unit of the server 200, reading out the code of the information processing program which is stored in the storage unit 240 into an unshown RAM and executing it.

Each symbol S in the flowchart in FIG. 4 refers to a step.

The flowchart described below is only an example of the information processing procedure in the first embodiment, and other steps may be added or some steps may be deleted.

Assuming that the user is holding the information processing device 100 and boarding on the mobility 1 (either as a driver or a passenger, the form of boarding is not limited), and the positional information acquisition unit 110 of the information processing device 100 acquires, at a predetermined cycle in the first embodiment, latitude and longitude information as positional information from GNSS satellite along with its accuracy value. These acquired information is then stored in the storage unit 140 of the information processing device 100, so as to associate with time information at which these information is acquired. These stored pairs of the observed value of positional information, the accuracy value and the time information are then transmitted to the server 200. The server 200 then stores the observed value of positional information, etc. transmitted from the information processing device 100, in the storage unit 240 (S1001).

Next, whether the accuracy value of the positional information at time t satisfies a predetermined condition is determined (S1003). Specifically, the accuracy value indicates the degree of accuracy with which the positional information was acquired at time t. If the accuracy is low, the value is determined as inappropriate for use in the processes for acquiring velocity and acceleration in the travelling direction and for acquiring angular velocity, which are described later. The intent is to eliminate positional information with low accuracy from these processes. Here, if the accuracy value satisfies the predetermined condition (as an example, not a limitation, the DOP value is less than a predetermined threshold (e.g., 5 m)) (S1003; Y), the process for acquiring an observed velocity value and an observed azimuth value take place, and if the accuracy value does not satisfy the predetermined condition (S1003; N), the positional information at time t is not determined as sufficiently accurate, and the observed value of the positional information are discarded and proceed to step S1011 without performing the processes thereafter.

In S1005, the velocity acquisition unit 220 acquires an observed value of positional information at time t and an observed value of positional information acquired at one cycle before time t in the acceleration information acquisition cycle (or just before the time when the accuracy value satisfies the condition) from the storage unit 240, and based on these information, acquires an observed velocity value at time t (S1005).

Similarly, in S1007, the azimuth acquisition unit 230 acquires an observed azimuth value at time and an observed azimuth value acquired at one cycle before time t (or before the time when the accuracy value satisfies the condition) and based on these information, acquires an observed angle velocity value at time t (S1007).

These acquired observed velocity value and observed azimuth value are associated with time t, respectively, and stored in storage unit 240 (S1009).

When step S1009 is completed, whether an observed value of positional information to be acquired remains, in other words, whether an observed value of target positional information is stored in the storage unit 240 is determined (S1011). If an observed value of positional information to be acquired remains (S1011; Y), the time t is updated to t+1, and repeat the processes from S1001. If an observed value of positional information to be acquired does not remain (S1011; N), this process for acquiring an observed velocity value and an observed azimuth value is terminated.

Note that the order of the process for acquiring an observed velocity value in S1005 and the process for acquiring the observed angular velocity value in S1007 is irrelevant. Also, the processes of S1005 and S1007 may be performed in parallel.

FIG. 5 is a flowchart showing an example of the procedure for acquiring an acceleration value in the traveling direction and an acceleration value in the vertical direction of the mobility 1 at time tin the first embodiment.

The process in the flowchart in FIG. 5 is performed, similar to the process shown in FIG. 4, for example, by the processing unit of server 200, reading out the code of the information processing program stored in the storage unit 240 into an unshown RAM and executing it.

First, the velocity and travelling direction acceleration acquisition unit 250 and the angular velocity acquiring unit 260 respectively acquire the observed velocity values and the observed azimuth values stored in the storage unit 240, going back in time for a predetermined number or a predetermined period of time from time t (S1101).

Next, the velocity and travelling direction acceleration acquisition unit 250 performs the process for acquiring an acceleration value in the travelling direction and a state velocity value of the mobility 1 at time t (S1103).

In the first embodiment, the acquisition of an acceleration value in the travelling direction of the mobility 1 and the acquisition of a state velocity value are performed by setting up a state-space model in which the displacement per unit time of state velocity values is an acceleration value in the travelling direction, and solving it. Hereinafter, an example of solving this state-space model where a linear model is set up and the Kalman filter is applied will be described. Here, a filter to be applied is not limited to the Kalman filter, and for example, a particle filter may be applied, and the set model is not limited to a linear model, but may also be a nonlinear model.

For acquiring a state velocity value and an acceleration value in the travelling direction, a state-space model is set as follows:

uₜ=vₜ+εᵥ

vₜ=vₜ₋₁+aₜ₋₁^{(x)}Δt

aₜ^{(x)}=aₜ₋₁^{(x)}+εₐ [Mathematical Formula 1]
uₜ : observed velocity value at time t
vₜ : state velocity value at time t
aₜ^{(x)}: acceleration value in travelling direction x at time t

By inputting observed velocity values into the model and applying the assumption that each additive term E follows a Gaussian distribution with mean 0, acceleration values in the travelling direction x and state velocity values are acquired.

In other words, to explain the process for acquiring acceleration values in the travelling direction and state velocity values using the Kalman filter in the first embodiment, a state-space model is set up in which the displacement per unit time of state velocity values is an acceleration value in the travelling direction, and an observed velocity value is a sum of a state velocity value and an additive term (for example, a value considering effects of noise, etc.) following a Gaussian distribution with mean 0, and the displacement per unit time of acceleration values in the travelling direction follows a Gaussian distribution with mean 0, and by inputting acquired observed velocity values into the state-space model, an acceleration value in the travelling direction and/or a state velocity value are acquired.

In addition, the angular velocity acquisition unit 260 performs a process for acquiring an angular velocity value of the mobility 1 at time t based on observed azimuth values acquired from the storage unit 240 (S1105).

Similar to the process for acquiring an acceleration value in the travelling direction and so on as described above, in the present invention, an angular velocity value of the mobility 1 is acquired by setting up a state-space model in which the displacement per unit time of state azimuth values is an angular velocity value, and solving it. For solving the state-space model, similar to the process for acquiring an acceleration value in the travelling direction and a state velocity value as described above, in the first embodiment, an example in which a linear model is set up and the Kalman filter is applied will be described below. However, the method of solving the model is not limited to this. The filter to be applied is not limited to the Kalman filter, for example, a particle filter may be applied, and the model to be set up is not limited to a linear one, but may also be a nonlinear model, of course.

To acquire a state azimuth value and an angular velocity value, first, a state-space model is set up as follows.

θₜ=Πₜ+εhd θ

Πₜ=Πₜ₋₁+ωₜ₋₁Δt

ωₜ=ωₜ₋₁+ε_{ω} [Mathematical Formula 2]
θₜ: observed azimuth value at time t
Πₜ: state azimuth value at time t
ωₜ: angular velocity value at time t

By inputting observed azimuth values into the model, and assuming that the distribution of each additive term ε follows a Gaussian distribution with mean 0, an angular velocity value can be acquired. Here, a state azimuth value may also be acquired.

In other words, to explain the process for acquiring an angular velocity value using the Kalman filter in the first embodiment, a state-space model is set up in which the displacement per unit time of state azimuth values is an angular velocity value, and an observed azimuth value is a sum of a state azimuth value and an additive term following a Gaussian distribution with mean 0, and the displacement per unit time of angular velocity values follows a Gaussian distribution with mean 0, and by sequentially inputting observed azimuth values into the state-space model, an angular velocity value and so on are acquired.

Note that the order of the process for acquiring an acceleration value in the travelling direction in S1103 and the process for acquiring an angular velocity value in S1105 is irrelevant. Also, the processes of S1103 and S1105 may be performed in parallel.

Next, the vertical direction acceleration acquisition unit 270 acquires an acceleration value in the vertical direction with respect to the travelling direction of the mobility 1 (S1107). Here, an acceleration value in the vertical direction may be calculated from the acquired acceleration values in the travelling direction using, for example, a trigonometric function. However, when a trigonometric function is used, rounding errors in numerical calculations may adversely affect the final calculation results.

Here, if it is sufficient to acquire an acceleration value in a short time unit, for example, a few milliseconds to a few seconds, even assuming that a motion of the mobility is acquired geometrically, the effect is not significant. So, for example, an acceleration value in the vertical direction can be acquired using the equation by Mathematical Formula 3, which projects a state velocity value to the vertical direction based on the angular velocity value per unit time.

a^{(y)}=v sin ω [Mathematical Formula 3]
a^{(y)}: Acceleration value in vertical direction y
v: State velocity value
ω: Angular velocity value

The above process is repeated for each time t, t+1, t+2, . . . , while observed velocity values and observed azimuth values are repeatedly input to the state-space models to be solved to acquire a corresponding acceleration value in the travelling direction, a state velocity value, an angular velocity value, and an acceleration value in the vertical direction.

Here, it is expected that the effect if circular motion is assumed as the movement of the mobility for a short period of time is not significant. The radius of curvature r of the mobility 1 can be acquired by inputting an acquired state velocity value and angular velocity value into the second equation of the following Mathematical Formula 4. This radius of curvature r, as well as other information about the mobility, can be used for some analysis of the mobility, for example, to determine whether the user carrying the information processing device 100 is a driver of the vehicle, to determine the degree of safe driving, and what type of vehicle (e.g., sedan, minivan, bus, light/medium/large truck, etc.) the user is using at the time of the observation.

r=const.

v=rω [Mathematical Formula 4]

The radius of curvature r is used to explain the process related to determining whether the user carrying the information processing device 100 is boarding as a driver.

It is assumed that a mobility boarded by the user is right-hand drive.

The radius of curvature of when a mobility passes through a curve is a value with respect to the center of the mobility, but when the user of the information carrying device 100 is in the driver's seat or in a front passenger seat, the radius of curvature becomes a value with respect to the position of the information processing device 100, and therefore it is expected that there will be a discrepancy from the value with respect to the center of the mobility. That is, in a right curve, if the user is in a driver's seat, it is expected that its value of the radius of curvature is smaller than the value of the radius of curvature with respect to the center of the vehicle. Conversely, if the user is in a front passenger seat, its value of the radius of curvature is expected to be larger than the value of the radius of curvature with respect to the center of the mobility.

With this assumption taken into account, whether the user is a driver is determined. For example, the following specific process is used.

When a mobility driven by the user as a driver enters and passes a certain curve, the value of the radius of curvature is acquired correspondingly. The information about the curve (e.g., positional information), the direction of entry, the acquired radius of curvature value, and the fact that the user is the driver are together stored so as to associate each other. The same direction of entry is used again to enter this curve, and a new value of the radius of curvature is acquired. If the newly acquired radius of curvature value is substantially the same as the previously acquired radius of curvature value, the user is judged to be a driver. If the values are so different that they are not nearly the same, the user is judged to be a non-driver.

Here, if the curve is a rightward curve, the value of the radius of curvature acquired when the user is a driver is smaller than the value of the radius of curvature acquired when the user is a non-driver. Conversely, if the curve is a leftward curve, the radius of curvature value acquired when the user is a driver is larger than the radius of curvature value acquired when the user is a non-driver.

Here, whether the determined user is a driver or not should be valid during the period from when the engine of the mobility starts until it stops, including the time of re-entry to the curve for this determination. In the case that the engine has stopped once and started again, it is preferable to reset the judgment and judge it again, since it may not be maintained that the user is a driver or a non-driver.

These acquired information, in other words, the state velocity value, the acceleration value in the travelling direction, the angular velocity value, and the acceleration value in the vertical direction, are stored in storage unit 240. Here, the state azimuth value, the radius of curvature, and so on may also be stored in storage unit 240.

These accumulated information are used for various purposes, e.g., for the driving evaluation process by the driving evaluation unit 280.

### Second Embodiment

Next, a second embodiment for realizing the information processing technology of the present invention is described.

The contents described in the second embodiment are applicable to each of the other embodiments, each of the examples, and each of the other variations, as well as the ones described in the first embodiment.

The difference between the first and second embodiments is that the first embodiment uses velocity and acceleration, as well as azimuth and angular velocity to set up a state-space model, while the second embodiment uses velocity, acceleration and jerk to set up a state-space model, and uses azimuth, angular velocity and angular acceleration to set up another state-space model. In other words, the second embodiment uses a state-space model with one more layer than the first embodiment.

Therefore, since the system configuration and the components provided by each device are identical, the following description of the second embodiment will only touch on the state-space models and the information processing procedures regarding such state-space models.

### [Information Processing Procedures]

The procedures for acquiring an observed velocity value and an observed azimuth value, and storing these values in the second embodiment are the same as those described with reference to FIG. 4 in the first embodiment, so the description thereof is omitted.

The difference between the first and second embodiments, such as the processes for acquiring an acceleration value in the travelling direction, a state velocity value and an angular velocity value, are explained below.

The processes for acquiring an acceleration value in the travelling direction, a state velocity value and an angular velocity of the mobility 1 at time t in the second embodiment are similar to that of the first embodiment, so the description thereof is made also with reference to the flowchart in FIG. 5.

First, the velocity and travelling direction acceleration acquisition unit 250 and the angular velocity acquisition unit 260 respectively acquire observed velocity values and observed azimuth values stored in the storage unit 240, going back in time for a predetermined number of minutes or a predetermined period of time from time t (S1101).

Next, the velocity and travelling direction acceleration acquisition unit 250 performs the process for acquiring an acceleration value in the travelling direction and a state velocity value of the mobility 1 at time t (S1103).

In the second embodiment, the state velocity value of the mobility 1 and the acceleration value in the travelling direction are acquired by setting up a state-space model in which the displacement of state velocity values per unit time is an acceleration value in the travelling direction, and the displacement of acceleration values in the travelling direction is a jerk value, and solving it. For solving the state-space model, similar to the first embodiment, a linear model is set up and the Kalman filter is applied, but the solving method is not limited to this, and the applied filter is not limited to the Kalman filter. For example, a particle filter may be applied, and the set model is not limited to linear one, but may also be a nonlinear model.

For acquiring a state velocity value and an acceleration value in the travelling direction, the state-space model is set up as follows.

uₜ=vₜ+εᵥ

vₜ=vₜ₋₁+aₜ₋₁^{(x)}Δt

aₜ^{(x)}=aₜ₋₁^{(x)}+aₜ₋₁^{(x)}Δt

a′ₜ^{(x)}=a′ₜ₋₁^{(x)}+ε_{a′}
uₜ: Observed velocity value at time t
vₜ: State velocity value at time t
aₜ^{(x)}: Acceleration value in travelling direction x at time t
a′ₜ^{(x)}: Jerk value in travelling direction x at time t

By inputting observed velocity values into the model and assuming that each additive term ε follows a Gaussian distribution with mean 0, acceleration values in the travelling direction x and state velocity values are acquired. Jerk values in the travelling direction may also be acquired.

In other words, to explain the process for acquiring an acceleration value in the travelling direction and a state velocity value using the Kalman filter in the second embodiment, the displacement per unit time of state velocity values is an acceleration value in the travelling direction, the displacement per unit time of acceleration values in the travelling direction is a jerk value in the travelling direction, an observed velocity value is a sum of a state velocity value and an additive term that follows a Gaussian distribution with mean 0, and the displacement per unit time of jerk values in the travelling direction follows a Gaussian distribution with mean 0, and by sequentially inputting acquired observed velocity values into the state-space model, acceleration values in the travelling direction and so on are sequentially acquired.

On the other hand, the angular velocity acquisition unit 260 acquires an angular velocity of the mobility 1 at time t based on information stored in the storage unit 240 in S1101 (S1105).

Similar to the process for acquiring an acceleration value in the travelling direction as described above, in the second embodiment, an angular velocity value of the mobility 1 is acquired by setting up a state-space model in which the displacement per unit time of state azimuth values is an angular velocity value, and the displacement per unit time of angular velocity values is an angular acceleration value, and solving it. For solving the state-space model, similar to the process for acquiring an acceleration value in the travelling direction as above, a linear model is set up and the Kalman filter is applied, but the solving method is not limited to this, and the applied filter is not limited to the Kalman filter. For example, a particle filter may be applied, and the set model is not limited to linear one, but may also be a nonlinear model.

To acquire a state azimuth value and an angular velocity value, the state-space model is first set up as follows.

θₜ=Πₜ+ε_{θ}

Πₜ=Πₜ₋₁+ωₜ₋₁Δt

ωₜ=ωₜ₋₁+ω′ₜ₋₁Δt

ω′ₜ=ω′ₜ₋₁+ε_{ω′}
θₜ: Observed azimuth value at time t
Πₜ: State azimuth value at time t
ωₜ: Angular velocity value at time t
ω′ₜ: Angular acceleration value at time t

By inputting observed azimuth values into the model, assuming that each additive term ε follows a Gaussian distribution with mean 0, angular velocity values and state velocity values are acquired. State azimuth values and angular acceleration values may also be acquired.

In other words, to explain the process for acquiring an angular velocity value using the Kalman filter in the second embodiment, a state-space model is set up in which the displacement per unit time of state azimuth values is an angular velocity value and the displacement per unit time of angular velocity values is an angular acceleration value, and an observed azimuth value is a sum of a state azimuth value and an additive term that follows a Gaussian distribution with mean 0, and the displacement per unit time of angular acceleration values follows a Gaussian distribution with mean 0, and by sequentially inputting acquired observed velocity values into the state-space model, an angular velocity value is acquired.

Note that the order of the process for acquiring an acceleration value in the travelling direction in S1103 and the process for acquiring an angular velocity value in S1105 is irrelevant. Also, the processes of S1103 and S1105 may be performed in parallel.

Next, the vertical direction acceleration acquisition unit 270 acquires an acceleration value in the vertical direction with respect to the travelling direction of the mobility 1 (S1107). The method for acquiring an acceleration value in the vertical direction is the same as in the first embodiment, so the description thereof is omitted here.

Further, a radius of curvature r of the mobility 1 can be acquired based on the acquired state velocity value and the angular velocity value. The method of acquiring the radius of curvature r is the same as in the first embodiment, so the description thereof is omitted.

These acquired information, i.e., a state velocity value, an acceleration value in the travelling direction, and an acceleration value in the vertical direction, are stored in storage unit 240. Here, in addition, the jerk value in the travelling direction, the state azimuth value, the angular acceleration value, and the radius of curvature may also be stored in the storage unit 240.

These accumulated information are used for various purposes, e.g., for the driving evaluation process by the driving evaluation unit 280.

### [The Action and Effect of the Present Invention]

According to the present invention, as information about the movement of a mobility, at least some of, for example, an acceleration value in the travelling direction, an acceleration value in the vertical direction, a state velocity value, a state azimuth value, an angular velocity value, a jerk value in the travelling direction, an angular acceleration value, and a radius of curvature, can be properly acquired.

### MODIFICATION EXAMPLES

In the above explanation, after the positional information acquisition unit 110 acquires the accuracy value along with the observed value of positional information, and stores them in the storage unit 240 so as to associate with the time information, when the velocity acquisition unit 220 or the azimuth acquisition unit 230 extracts the observed value of positional information from the storage unit 240, it is determined whether or not the accuracy value satisfies a predetermined condition, and from the result thereof, whether or not the observed value of positional information can be used for the process by the velocity acquisition unit 220 or the process by the azimuth acquisition unit 230. However, the procedure is not limited to this content.

For example, at the time that the positional information acquisition unit 110 acquires the observed value of positional information, if the corresponding accuracy value does not satisfy the predetermined condition, then such observed value of positional information may not be transmitted to server 200. Alternatively, such observed value of positional information may be transmitted to server 200 but not stored in storage unit 240. Furthermore, the acquisition of a velocity value by the velocity acquisition unit 220 and the acquisition of an azimuth value by the azimuth acquisition unit 230 may be performed with the observed value of positional information regardless of whether the accuracy value satisfies the predetermined condition, and when the velocity and travelling direction acceleration acquisition unit 250 is to acquire a predetermined number or a predetermined period of time of observed velocity values and the angular velocity acquisition unit 260 is to acquire a predetermined number or a predetermined period of time of observed azimuth values (S1101), if the accuracy value that was stored so as to associate with the corresponding time information does not satisfy the predetermined condition, these information may not be acquired and therefore not used for the processes by the velocity and travelling direction acceleration acquisition unit 250 and the angular velocity acquisition unit 260. In other words, the result of the judgment as to whether the accuracy value satisfies the predetermined condition should be reflected somewhere during the overall processes as to whether to use the corresponding observed value of positional information or observed velocity value and/or observed azimuth value, and the timing is not limited to any particular point.

In the state-space model in the first embodiment and in the state-space model in the second embodiment, each additive term follows a Gaussian distribution with mean 0, but the additive term is not limited to this fashion. For example, at least one of the additive terms may follow a Gaussian distribution with a non-zero mean, or it may follow any distribution that is not Gaussian (e.g., Cauchy distribution), and the mean value and the type of distribution are not limited.

In the first embodiment, information about the movement of the mobility 1 is acquired by the two-layer state-space model of “velocity”-“acceleration” and “azimuth”-“angle velocity”, and in the second embodiment, information about the movement of the mobility 1 is acquired by the three-layer model of “velocity”-“acceleration”-“jerk” and “azimuth”-“angle velocity”-“angle acceleration”. However, the number of layers in the state-space model is not limited to this. In other words, it is possible to acquire information about the movement of the mobility 1 by a state-space model consisting of n layers (n is a natural number greater than or equal to 2).

That is, a state-space model where the first layer element is an equation indicating a relation that the observed velocity value is a sum of a state velocity value and an additive term following a Gauss distribution with mean 0, the second layer is an equation indicating a relation of displacement per unit time of the state velocity values, the k+1-th layer is an equation indicating a relation of the displacement per unit time of the displacement values per unit time at the k-th layer, n is a predetermined natural number greater than or equal to 2, k is a natural number being not less than 2 and less than n, and the n+1-th layer is an equation indicating that the displacement per unit time of the displacement values per unit time at the n-th layer follows a Gaussian distribution with mean 0, is set up. By inputting observed velocity values based on corresponding time information into this state-space model, an acceleration value in the travelling direction and/or a state velocity value of the mobility 1 can be acquired.

Similarly, a state-space model where the first layer element is an equation indicating a relation that the observed azimuth value is a sum of a state azimuth value and an additive term value following a Gaussian distribution with mean 0, the second layer is an equation indicating a relation of the displacement per unit time of the state azimuth values, the k+1-th layer is an equation indicating a relation of the displacement per unit time of a displacement values per unit time at the k-th layer, where n is a predetermined natural number being not less than 3, k is a natural number being not less than 2 and less than the n, and the n+1-th layer is an equation indicating that the displacement per unit time of displacement values per unit time at an n-th layer follows a Gaussian distribution with mean 0. By inputting observed azimuth values based on corresponding time information into this state-space model, an angular velocity value can be acquired.

According to the above explanation, acquiring an observed value of positional information is performed by the information processing device 100, and the subsequent processes up to the acquisition of an acceleration value in the travelling direction, etc., are performed by the server 200. However, the location to perform the processes is not limited to this, for example, some or all of these processes are performed by devices other than the server 200 (e.g., a device installed in the mobility 1, such as a drive recorder).

For example, the information processing device 100 may have functional parts corresponding to the velocity acquisition unit 220, the azimuth acquisition unit 230, the storage unit 240, the velocity and travelling direction acceleration acquisition unit 250, the angular velocity acquisition unit 260, and the vertical direction acceleration acquisition unit 270, and each process may be performed by the cooperation of these functional parts. Therefore the locations of the parts are not limited.

After the completion of the process for calculating a driving evaluation score, the calculation result is transmitted to the information processing device 100 and output on the display unit 130. Thereby the calculation result may be presented to a user of the information processing device 100.

Furthermore, according to the above explanation, driving evaluation is performed by the driving evaluation unit 280 using the acquired acceleration values in the travelling direction and the acceleration values in the vertical direction, but the information used is not limited to such acceleration values. For example, state velocity values, state azimuth values, angular velocity values, jerk values in the travelling direction, angular acceleration values, radius of curvature, etc. are output, as well as other types of information (not limited, but examples include temperature information, humidity information, weather information, altitude information, driver fatigue information, etc.) acquired from another device and these information may also be used for performing the driving evaluation.

Furthermore, according to the above explanation, the driving evaluation is performed based on information about the movement of the mobility 1, but the use of information about the movement of the mobility 1 is not limited to the driving evaluation. For example, based on the information about the movement of the mobility 1, it is possible to determine what type of mobility 1 is (passenger car, bicycle, bus, vessel, or on foot), or to determine whether the user of the mobility 1 is a driver or non-driver. In this case, the server 200 may have the corresponding functional parts for determining the type of mobility 1 and a driver or non-driver, or the information may be transmitted to a device other than the server 200 and processed by the corresponding functional part of that device.

The information used as positional information is not limited to that described above, but may be any information that can be received from outside the mobility that can be used to identify the location. For example, a beacon containing positional information may be received and used as positional information by processing it alone or in combination with GPS information.

Furthermore, according to the above description, velocity is acquired by the velocity acquisition unit 220, but the acquisition of velocity is not limited to this. For example, the mobility 1 may be equipped with an unshown vehicle velocity pulse acquiring unit and communication unit, and the velocity of the mobility 1 may be acquired based on the vehicle velocity pulse information acquired by said vehicle velocity pulse acquiring unit, or the acquired vehicle velocity pulse information may be transmitted to the information processing device 100 or server 200 and the velocity of the mobility 1 is calculated in combination with the observed value of positional information. The form of acquiring velocity is not limited specifically.

Although there is no restriction on the cycle of acquiring positional information, it is known that situations where severe vibration can occur, such as vibration caused by engines and vibration caused by driving on rough roads (transportation vibration frequencies), have an adverse effect on acquiring information about the movement of the mobility. Therefore, in order to minimize the influence of these transport vibration frequencies, it is desirable to set the cycle of acquiring positional information within a range that does not resonate with these frequencies. In this regard, truck transportation is the most affected by vibration in land transportation among air transportation, rail transportation, etc., and its transportation vibration frequency is known to often occur between 2 Hz and 20 Hz. Therefore, in order to avoid the influence of the aforementioned transport vibration frequency, the frequency of acquiring positional information should preferably be 20 Hz or higher, or 2 Hz or lower. In this way, it is possible to make it less susceptible to the effects of transport vibration frequencies. In addition, when the frequency is 2 Hz or lower, the frequency of acquiring positional information becomes smaller, and the frequency of process that takes place correspondingly also becomes smaller, which has the effect of reducing power consumption.

In view of the adverse effects of transport vibration frequencies on acceleration acquisition, as mentioned above, according to the performance of the mobility (including but not limited to suspension performance, tire performance, etc. further, it is also desirable to consider wear and performance degradation of these devices over a period of use), road conditions, and loading capacity, etc., the cycle of acquiring positional information may be made changeable. For example, the mobility 1 or the information processing device 100 may be equipped with an acquiring unit that is not shown in the figure, and the acquiring unit may acquire information on the performance of the mobility, road conditions, loading capacity of the mobility, etc., and the cycle of acquiring positional information may be varied according to the information. In this way, it is possible to acquire positional information with less noise according to the situation.

Furthermore, according to the explanation above, it was explained that the cycle of acquiring observed values of positional information is the same as the cycle of acquiring acceleration information, but the relationship between these two cycles is not particularly limited. For example, it is preferable that the cycle of acquiring observed values of positional information is less than or equal to the cycle of acquiring acceleration information. In other words, it is preferable that two consecutive observed values of positional information corresponding to the acceleration information acquisition are acquired at different times. Furthermore, it is preferable that the cycle of acquiring acceleration information be a natural multiple of the cycle of acquiring observed values of positional information. If these two cycles are not the same, the observed values of positional information acquired in S1001 is stored in the storage unit 240, and in S1005 or in S1007, the corresponding observed values of positional information are retrieved from storage unit 240 based on the cycle of acquiring acceleration information, to be processed.

Furthermore, according to the above explanation, it is assumed that the motion by the mobility is acquired geometrically, and acceleration value in the vertical direction is acquired based on information pertaining to the travelling direction. However, the method of acquiring acceleration value in the vertical direction is not limited to this. For example, assuming that the motion by the mobility is a constant velocity circular motion, the acceleration value in the vertical direction may be acquired based on the information related to the direction of motion. In this case, the acceleration value in the vertical direction can be acquired using the Mathematical Formula 7.

r=const.

v=rω=const.

a^{(y)}=vω [Mathematical Formula 7]

Thus, the motion by the mobility may be assumed to be some formulable motion, and the method of assumption is not limited as long as it does not deviate from the nature of the motion by the mobility.

Furthermore, according to the above explanation, both an acceleration value in the travelling direction and a state velocity value are acquired. However, only one of them may be acquired arbitrarily, depending on the application. In other words, only any of the following information may be acquired: an acceleration value in the travelling direction, an acceleration value in the vertical direction, a state velocity value, a state azimuth value, an angular velocity value, a jerk value in the travelling direction, an angular acceleration value, and a radius of curvature.

Furthermore, according to the above explanation, the cycle of acquiring observed velocity values (hereinafter referred to as “velocity acquisition cycle”) and the cycle of acquiring observed azimuth values (hereinafter referred to as “azimuth acquisition cycle”) are the same and are acquired at the same time (that is, both the values are acquired at time t+1, t+1, . . . ), but these cycles are not limited in this way. These two cycles do not have to be the same, nor the two values do not have to be acquired at the same timing.

Here, for example, it is preferable that the velocity acquisition cycle is greater than or equal to the azimuth acquisition cycle. In this way, when an acceleration value in the vertical direction based on the Mathematical Formula 3 or 7 is to be acquired, it can be avoided that angular velocity values or sine values of angular velocity values to be multiplied with two consecutive state velocity values are the same.

Furthermore, for example, it is preferable that the velocity acquisition cycle be synchronized with the azimuth acquisition cycle. Here, “synchronized” means that the cycle of one is a natural multiple of that of another. In this way, when acceleration values in the vertical direction are to be acquired based on the Mathematical Formula 3 or 7, one angular velocity value corresponds to a predetermined number of consecutive state velocity values, or one state velocity value corresponds to a predetermined number of consecutive angular velocity values, and therefore acceleration values in the vertical direction with less time-series discomfort can be acquired.

Although the invention has been described in detail above, the scope of the invention is not limited to the above embodiments and variations. Various improvements and modifications of the above embodiments and variations are possible to the extent that they do not depart from the main purpose of the invention. Also, the above embodiments and modifications can be combined.

### DESCRIPTION OF SIGNS

1 Mobility
100 Information processing device
110 Positional information acquisition unit
200 Server
220 Velocity acquisition unit
230 Azimuth acquisition unit
240 Storage unit
250 Velocity and travelling direction acceleration acquisition unit
260 Angular velocity acquisition unit
270 Vertical direction acceleration acquisition unit
280 Driving evaluation unit

1. A mobility movement information acquiring method comprising:
acquiring positional information of a mobility based on GPS;
acquiring an observed velocity value of the mobility based on the positional information, according to a first interval;
storing the observed velocity value and corresponding first time information so as to relate each other; and
acquiring an acceleration value in a travelling direction of the mobility and a state velocity value by inputting the observed velocity value based on the first time information into a first state-space model in which:
displacement per unit time of the state velocity value is the acceleration value in the travelling direction,
the observed velocity value is a sum of the state velocity value and a value following a first distribution, and
displacement per the unit time of the acceleration value in the travelling direction follows a second distribution.

2. The method according to claim 1, wherein at least one of a mean value of the first distribution and a mean value of the second distribution is equal to 0.

3. The method according to claim 1, wherein at least one of the first distribution and the second distribution is Gauss distribution.

4-5. (canceled)

6. The method according to claim 1, wherein
the acquiring the positional information includes acquiring a precision value of the positional information, and
the acquiring the observed velocity information is performed when the precision value satisfies a predetermined condition.

7. The method according to claim 1, wherein a frequency corresponding to the second interval is not less than 20 Hz or not more than 2 Hz.

8. The method according to claim 1, further comprising:
acquiring at least one of performance information of the mobility, road circumstance information, and loading weight information of the mobility, and
changing an interval of the acquiring positional information based on the at least one of performance information of the mobility, road circumstance information, and loading weight information of the mobility.

9-14. (canceled)

15. A mobility movement information acquiring method comprising:
acquiring positional information of a mobility based on GPS;
acquiring an observed azimuth value of the mobility based on the positional information o according to a second interval;
storing the observed azimuth value and corresponding second time information so as to relate each other;
acquiring an angular velocity value of the mobility by inputting the observed azimuth value based on the second time information into a third state-space model in which:
displacement per unit time of a state azimuth value is the angular velocity value,
the observed azimuth value is a sum of the state azimuth value and a value following a third distribution, and
displacement per the unit time of the angular velocity value follows a fourth distribution.

16. A mobility movement information acquiring method comprising:
acquiring positional information of a mobility based on GPS;
acquiring an observed velocity value of the mobility based on the positional information according to a first interval;
storing the observed velocity value and corresponding first time information so as to relate each other; and
acquiring at least one of an acceleration value in a travelling direction of the mobility and a state velocity value, by inputting the observed velocity value based on the first time information into a second state-space model in which:
a first layer is an equation indicating a relation that the observed velocity value is a sum of the state velocity value and a value following a first distribution,
a second layer is an equation indicating a relation of displacement per unit time of the state velocity value,
a k+1 layer is an equation indicating a relation of displacement per unit time of a displacement value per unit time at a k-th layer,
n is a predetermined natural number being not less than 3,
k is a natural number being not less than 2 and less than the n, and
an n+1-th layer is an equation indicating that displacement per unit time of a displacement value per unit time at an n-th layer follows a fifth distribution.

17. (canceled)

18. A mobility movement information acquiring apparatus comprising:
a first acquiring section that acquires positional information of a mobility based on GPS:
a second acquiring section that acquires an observed velocity value of the mobility based on the positional information, according to a first interval;
a storing section that stores the observed velocity value and corresponding first time information so as to relate each other; and
a third acquiring section that acquires at least one of an acceleration value in a travelling direction of the mobility and a state velocity value of the mobility by inputting the observed velocity value based on the first time information into a first state-space model in which:
displacement per unit time of the state velocity value is the acceleration value in the travelling direction,
the observed velocity value is a sum of the state velocity value and a value following a first distribution, and
displacement per the unit time of the acceleration value in the travelling direction follows a second distribution.

19. A mobility movement information acquiring apparatus comprising:
a first acquiring section that acquires positional information of a mobility based on GPS:
a fifth acquiring section that acquires an observed azimuth value of the mobility based on the positional information, according to a second interval;
a storing section that stores the observed azimuth value and corresponding second time information so as to relate each other;
a sixth acquiring section that acquires an angular velocity value of the mobility by inputting the observed azimuth value based on the second time information into a third state-space model in which:
displacement per unit time of a state azimuth value is the angular velocity value,
the observed azimuth value is a sum of the state azimuth value and a value following a third distribution, and
displacement per the unit time of the angular velocity value follows a fourth distribution.

20. A mobility movement information acquiring apparatus comprising:
a first acquiring section that acquires positional information of a mobility based on GPS:
a second acquiring section that acquires an observed velocity value of the mobility according to a first interval;
a storing section that stores the observed velocity value and corresponding time first information so as to relate each other; and
a fourth acquiring section that acquires at least one of an acceleration value in a travelling direction of the mobility and a state velocity value of the mobility, by inputting the observed velocity value based on the time information into a second state-space model in which:
a first layer is an equation indicating a relation that the observed velocity value is a sum of the state velocity value and a value following a first distribution,
a second layer is an equation indicating a relation of displacement per unit time of the state velocity value,
a k+1 layer is an equation indicating a relation of displacement per unit time of a displacement value per unit time at a k-th layer,
n is a predetermined natural number being not less than 3,
k is a natural number being not less than 2 and less than the n, and
an n+1-th layer is an equation indicating that displacement per unit time of a displacement value per unit time at an n-th layer follows a fifth distribution.

21-25. (canceled)

26. A mobility movement information acquiring method comprising:
acquiring positional information of a mobility based on GPS;
acquiring an observed azimuth value of the mobility based on the positional information, according to a second interval;
storing the observed azimuth value and corresponding second time information so as to relate each other;
acquiring an angular velocity value by inputting the observed azimuth value based on the second time information into a fourth state-space model in which:
a first layer is an equation indicating a relation that the observed azimuth value is a sum of a state azimuth value and a value following a third distribution,
a second layer is an equation indicating a relation of displacement per unit time of the state azimuth value,
an l+1-th layer is an equation indicating a relation of displacement per unit time of a displacement value per unit time at an l-th layer,
m is a predetermined natural number being not less than 3,
l is a natural number being not less than 2 and less than the m, and
an m+1-th layer is an equation indicating that displacement per unit time of a displacement value per unit time at an m-th layer follows a sixth distribution.

27. A mobility movement information acquiring apparatus comprising:
a first acquiring section that acquires positional information of a mobility based on GPS;
a fifth acquiring section that acquires an observed azimuth value of the mobility based on the positional information, according to a second interval;
a storing section that stores the observed azimuth value and corresponding second time information so as to relate each other;
a seventh acquiring section that acquires an angular velocity value by inputting the observed azimuth value based on the second time information into a fourth state-space model in which:
a first layer is an equation indicating a relation that the observed azimuth value is a sum of a state azimuth value and a value following a third distribution,
a second layer is an equation indicating a relation of displacement per unit time of the state azimuth value,
an l+1-th layer is an equation indicating a relation of displacement per unit time of a displacement value per unit time at an l-th layer,
m is a predetermined natural number being not less than 3,
l is a natural number being not less than 2 and less than the m, and
an m+1-th layer is an equation indicating that displacement per unit time of a displacement value per unit time at an m-th layer follows a sixth distribution.

28. The mobility movement information acquiring method according to claim 15, further comprising:
acquiring a velocity value, and
acquiring an acceleration value in a vertical direction by projecting the velocity value to the travelling direction based on the angular velocity value, or by multiplying the velocity value and the angular velocity value.

29. The mobility movement information acquiring method according to claim 26, further comprising:
acquiring a velocity value, and
acquiring an acceleration value in a vertical direction by projecting the velocity value to the travelling direction based on the angular velocity value, or by multiplying the velocity value and the angular velocity value.

30. The mobility movement information acquiring apparatus according to claim 19, further comprising:
an eighth acquiring section that acquires a velocity value, and
a ninth acquiring section that acquires an acceleration value in a vertical direction by projecting the velocity value to the travelling direction based on the angular velocity value, or by multiplying the velocity value and the angular velocity value.

31. The mobility movement information acquiring apparatus according to claim 27, further comprising:
an eighth acquiring section that acquires a velocity value, and
a ninth acquiring section that acquires an acceleration value in a vertical direction by projecting the velocity value to the travelling direction based on the angular velocity value, or by multiplying the velocity value and the angular velocity value.

32. The mobility movement information acquiring method according to claim 1, further comprising:
acquiring an angular velocity value, and
acquiring an acceleration value in a vertical direction by projecting the velocity value to the travelling direction based on the angular velocity value, or by multiplying the velocity value and the angular velocity value.

33. The mobility movement information acquiring method according to claim 16, further comprising:
acquiring an angular velocity value, and
acquiring an acceleration value in a vertical direction by projecting the velocity value to the travelling direction based on the angular velocity value, or by multiplying the velocity value and the angular velocity value.

34. The mobility movement information acquiring apparatus according to claim 18, further comprising:
a tenth acquiring section that acquires an angular velocity of the mobility, and
an eleventh acquiring section that acquires an acceleration value in a vertical direction by projecting the velocity value to the travelling direction based on the angular velocity value, or by multiplying the velocity value and the angular velocity value.

35. The mobility movement information acquiring apparatus according to claim 20, further comprising:
a tenth acquiring section that acquires an angular velocity of the mobility, and
an eleventh acquiring section that acquires an acceleration value in a vertical direction by projecting the velocity value to the travelling direction based on the angular velocity value, or by multiplying the velocity value and the angular velocity value.
